(19) United States
(12) Patent Application Publication
(10) Pub. No.: US 2022/0006140 A1
(43) Pub. Date: Jan. 6, 2022

(54) BATTERY PACK AND COOLING SYSTEM THEREOF

(71) Applicant: Contemporary Amperex Technology Co., Limited, Ningde City (CN)

(72) Inventors: Yanlong GU, Ningde City (CN); Xueyu BAI, Ningde City (CN)

(73) Assignee: Contemporary Amperex Technology Co., Limited, Ningde City (CN)

(21) Appl. No.: 17/478,884

(22) Filed: Sep. 18, 2021

Related U.S. Application Data
(63) Continuation of application No. PCT/CN2020/077273, filed on Feb. 28, 2020.

(30) Foreign Application Priority Data
Mar. 18, 2019 (CN) 201920344391.7

(51) Int. Cl. H01M 10/6556; H01M 10/613; H01M 10/6568; H01M 50/204

(52) U.S. Cl. CPC H01M 10/6556; H01M 50/204; H01M 10/6568; H01M 10/613

(57) ABSTRACT

The present application provide a battery pack and a cooling system thereof. The cooling system includes: a collecting tube, including a body portion having a cooling flow channel; a cooling tube which is provided with a collecting tube at both ends along the axial direction and is in communication with the cooling flow channel of the collecting tube; the body portion is further provided with a mounting hole, a limiting boss is arranged inside the mounting hole, and abuts against the cooling tube along the axial direction. By disposing the limiting boss in the mounting hole, the cooling tube abuts against the limiting boss, which function to limit the cooling tube in the width direction, realize the connection between the cooling tube and the two collecting tubes, and limit the depth of the cooling tube entering into the mounting hole through the limiting boss.

### CROSS-REFERENCE OF RELATED APPLICATIONS

The present application is a continuation of International Application No. PCT/CN2020/077273, filed on Feb. 28, 2020, which claims priority to Chinese Patent Application No. 201920344391.7, filed on Mar. 18, 2019, both of which are hereby incorporated by reference in their entireties.

### TECHNICAL FIELD

The present application relates to the technical field of energy storage devices, in particular to a battery pack and cooling system thereof.

### BACKGROUND

With the increasing development of the power battery, the energy density of batteries is constantly increasing. However, the problem caused by the increase in energy density is the increase in the heat generation amount of the battery, so the requirement for the cooling efficiency of the cooling system of the battery is becoming more and more strict. The power battery can be cooled by water cooling, specifically by installing a cooling system in the battery pack. The cooling system includes a collecting tube and a cooling tube, and the cooling tube is connected with the collecting tube to realize the communication between the flow channels of the two tubes, so that the cooling liquid can circulate in the flow channels of the two tubes, so as to realize the cooling of the battery pack.

At present, when the existing collecting tube is connected with the cooling tube, it is necessary to punch a flanging hole in the collecting tube, and the cooling tube is provided with a necking structure. A step is formed at the necking structure and goes deeply into the flanging hole. A stamping operation is performed on a partial region of the collecting tube, and the stamped portion will protrude from the rest part in the vicinity to form a flanging hole. The end of the flanging hole abuts against the step of the necking structure, and the necking structure is welded to the flanging hole, thereby realizing the connection between the collecting tube and the cooling tube. However, when the cooling tube is provided with a necking structure, the cooling tube needs to be processed by the necking processing equipment, which reduces the production efficiency of the cooling tube and the cooling system. At the same time, the flow resistance of the cooling liquid at the necking structure of the cooling tube increases, which leads to an increase in the energy consumption of the water pump of the cooling system and reduces the energy utilization rate of the cooling system.

### SUMMARY

In view of this, embodiments of the present application provide a battery pack and a cooling system thereof to solve the problem of low production efficiency and low energy utilization rate of the cooling system in the prior art.

Embodiments of the present application provide a cooling system for a battery pack, the cooling system including:
a collecting tube including a body portion having a cooling flow channel;
a cooling tube, which is provided with the collecting tube at each of two ends of the cooling tube along an axial direction and is in communication with the cooling flow channel of the collecting tube,
wherein the body portion is further provided with a mounting hole, and a limiting boss is arranged inside the mounting hole. Along a width direction, the limiting boss abuts against the cooling tube, and the axial direction of the cooling tube is the width direction.

In the present application, by providing a limiting boss in the mounting hole of the collecting tube, the cooling tube can abut against the limiting boss, so as to limit the cooling tube in the width direction, realize the connection between the cooling tube and the two collecting tubes, and can limit the depth of the cooling tube entering into the mounting hole through the limit boss. At the same time, after the limiting boss is disposed in the collecting tube, there is no need to dispose a necking structure on the cooling tube, which can improve the production efficiency of the cooling system, can avoid the increase of the flow resistance of the cooling liquid caused by the cooling tube being disposed with the necking structure, and can improve the energy utilization rate of the cooling system.

In other aspect, embodiments of the present application further provide a battery pack, including:
a battery module including a plurality of unit cells;
the cooling system according to the above embodiments; the cooling tube is arranged under the battery module, and a bottom of the battery module and the cooling tube are in contact with each other; wherein the cooling system is configured for cooling the battery module.

### BRIEF DESCRIPTION OF THE DRAWINGS

In order to explain the technical solutions of embodiments of the present application more clearly, the drawings needed in the embodiments will be briefly introduced. Obviously, the drawings in the following description are only some embodiments of the present application. For the skilled person in the art, without inventive work, other drawings can be obtained from these drawings.

FIG. 1 is a schematic diagram of a partial structure of a battery pack provided by the present application in a specific embodiment;

FIG. 2 is a schematic diagram of the structure of the cooling system in FIG. 1;

FIG. 3 is a partial enlarged view of part I in FIG. 2;

FIG. 4 is a schematic diagram of the structure of the blocking cover in FIG. 3;

FIG. 5 is a top view of FIG. 2;

FIG. 6 is a sectional view taken along the line A-A of FIG. 5;

FIG. 7 is a partial enlarged view of part II in FIG. 6;

FIG. 8 is a schematic diagram of the structure of the collecting tube in FIG. 2;

FIG. 9 is a front view of FIG. 8;

FIG. 10 is a cross-sectional view taken along the line B-B of FIG. 9;

FIG. 11 is a partial enlarged view of part III in FIG. 9.

In the drawings, the drawings may not be drawn according to actual scale.

### REFERENCE SIGNS

1—collecting tube;

11—body portion;

111—cooling flow channel;

111a—second side wall;

112—first bottom wall;

12—protruding portion;

13—mounting hole;

131—first hole section;

131a—first side wall;

132—second hole section;

133—third hole section;

14—limiting boss;

15—liquid inlet;

16—liquid outlet;

2—cooling tube;

21—mounting section;

22—cooling section;

3—blocking cover;

31—third side wall;

311—inner concave portion;

32—second bottom wall;

4—battery module.

### DETAILED DESCRIPTION

In order to better understand the technical solutions of the present application, embodiments of the present application will be described in detail below with reference to the accompanying drawings.

It should be clear that the described embodiments are only a part of the embodiments of the present application, rather than all of the embodiments. Based on the embodiments in the present application, all other embodiments obtained by the skilled person in the art without inventive work shall fall within the protection scope of the present application.

The terms used in the embodiments of the present application are only for the purpose of describing specific embodiments, and are not intended to limit the present application. The singular forms of “a”, “said” and “the” used in the embodiments of the present application and the appended claims are also intended to include plural forms, unless the context clearly indicates other meanings.

It should be understood that the term “and/or” used in this text is only an associated relationship describing associated objects, indicating that there can be three types of relationships. For example, A and/or B can mean three cases: A alone exists, both A and B exist at the same time and B alone exists. In addition, the character “/” in this text generally indicates that the associated objects before and after are in an “or” relationship.

It should be noted that the “upper”, “lower”, “left”, “right” and other directional words described in the embodiments of the present application are described from the angle shown in the drawings, and should not be construed to limit the embodiments of the present application. In addition, in the context, it should also be understood that when it is mentioned that an element is connected “on” or “under” another element, it can not only be directly connected “on” or “under” the other element, but also it is indirectly connected “on” or “under” another element through an intermediate element.

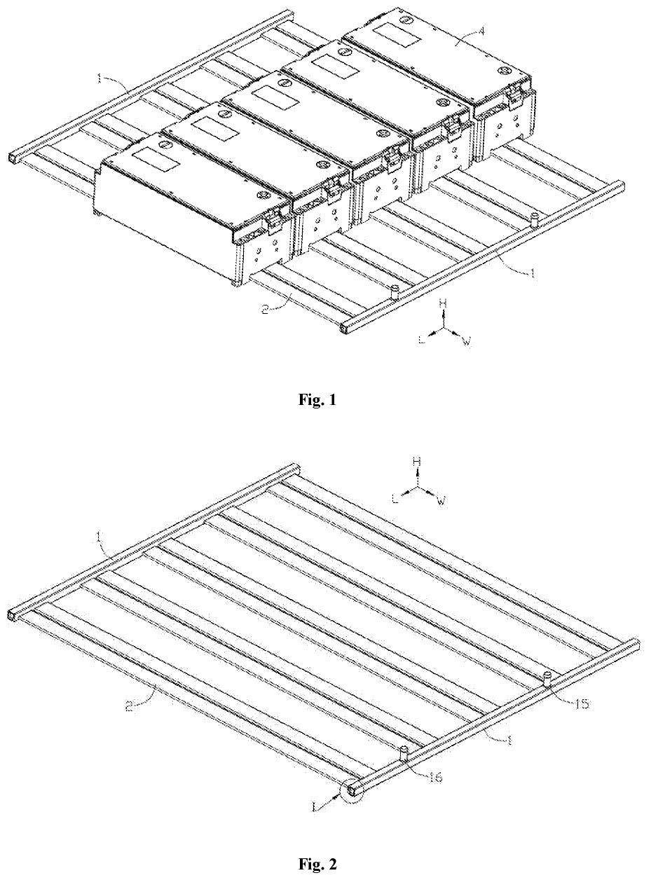

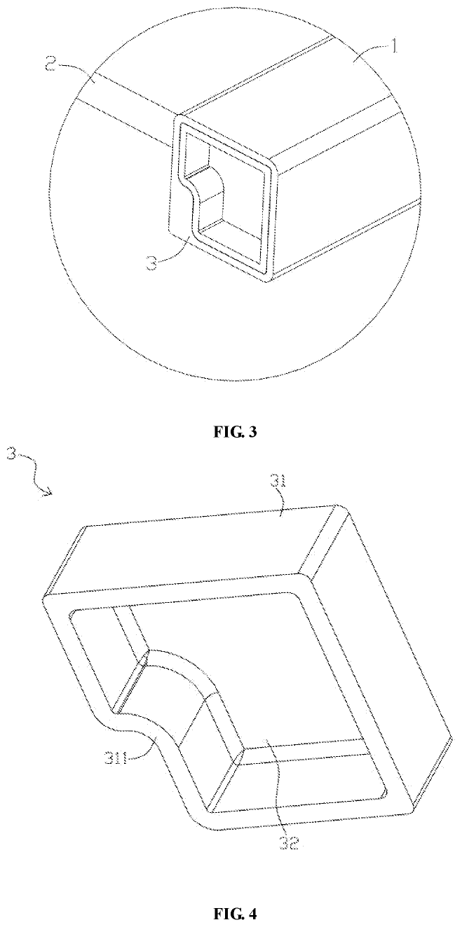

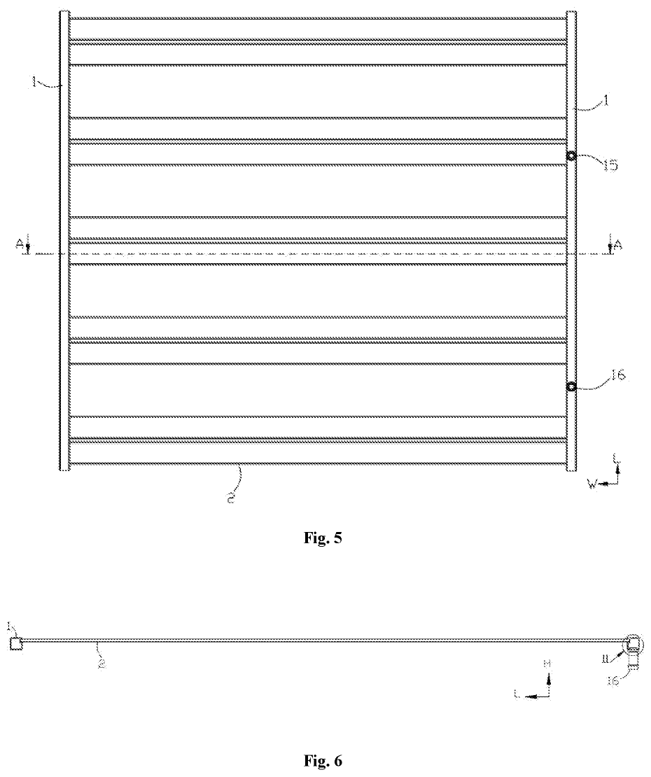

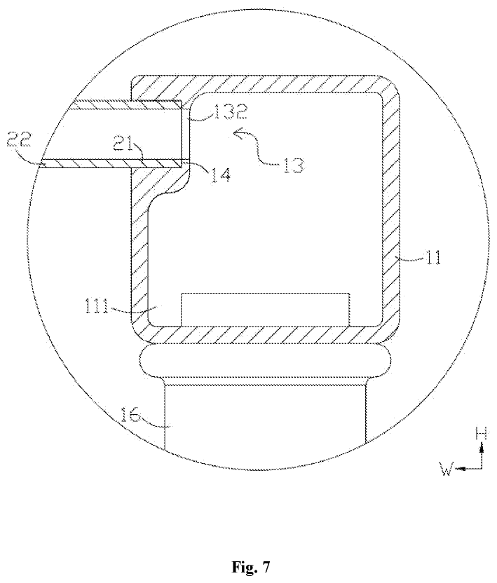

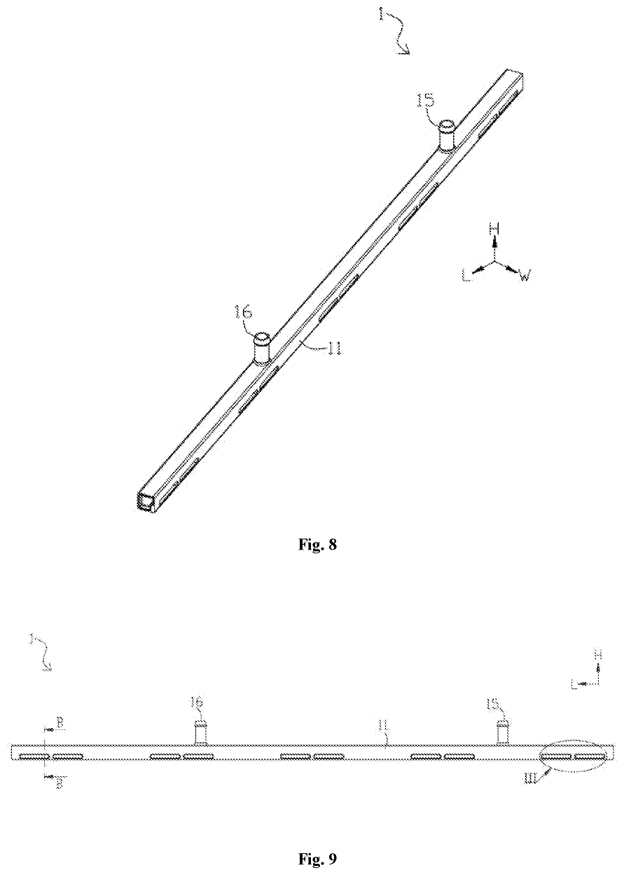

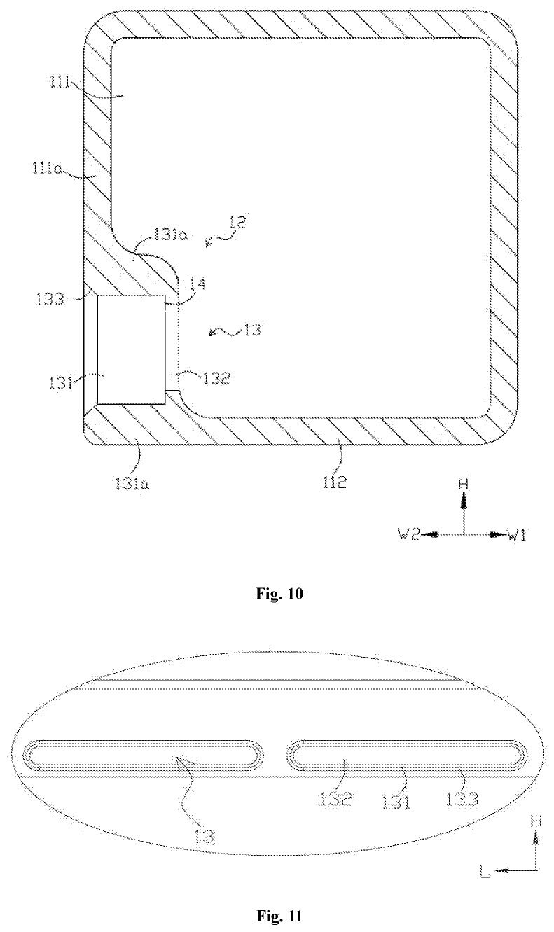

Refers to FIGS. 1 to 11, in which FIG. 1 is a partial structural diagram of the battery pack provided by the present application in a specific embodiment; FIG. 2 is a structural diagram of the cooling system in FIG. 1; FIG. 3 is a partial enlarged view of part I in FIG. 2; FIG. 4 is a schematic structural diagram of the blocking cover in FIG. 3; FIG. 5 is a top view of FIG. 2; FIG. 6 is a cross-sectional view taken along the line AA in FIG. 5; FIG. 7 is a partial enlarged view of part II in FIG. 6; FIG. 8 is a schematic diagram of the structure of the collecting tube in FIG. 2; FIG. 9 is a front view of FIG. 8; FIG. 10 is a cross-sectional view taken along the line BB of FIG. 9; FIG. 11 is a partial enlarged view of part III in FIG. 9.

Embodiments of the present application provide a battery pack and a cooling system thereof. As shown in FIG. 1, the battery pack includes a plurality of battery modules 4 stacked along its length direction L, and the battery module 4 includes a plurality of unit cells. The stacking direction of the battery module 4 is defined as the length direction L of the battery pack. At the same time, the battery pack also includes a casing (not shown in the figure), and each battery module 4 is located in the inner cavity of the casing. When the battery pack is operating, the unit cells in the battery module 4 generate heat. In order to ensure that the battery pack works at a suitable temperature, a cooling system is provided in the casing of the battery pack in the present application. The cooling system is used to cool each battery module 4 in the battery pack.

In an embodiment, as shown in FIG. 2, the cooling system includes a plurality of cooling tubes 2 along the length direction L of the battery pack. The cooling tubes 2 are parallel to each other and extend along the width direction W of the battery pack. The axial direction of the cooling tubes 2 is the width direction W of the battery pack. The width direction W of the battery pack is perpendicular to the length direction L. The cooling tube 2 may be a harmonica-shaped tube, that is, as shown in FIG. 2, the outside of the harmonica-shaped tube has a flat structure, and the inside of the harmonica-shaped tube has a plurality of passages distributed along the length direction L at intervals. The cooling tubes 2 are located below the battery module 4, and the bottom of the battery module 4 is connected with the flat cooling tubes 2 so that the bottom of the battery module 4 can exchange heat with the cooling tube 2.

In an embodiment, the cooling system further includes two collecting tubes 1. The two collecting tubes 1 are located at the two ends of the cooling tube 2 in the width direction W, respectively. The collecting tube 1 has a cooling flow channel 111 extending in the length direction L inside. The cooling flow channel 111 is used for cooling liquid to circulate. After the above-mentioned cooling tube 2 is connected to the collecting tube 1, the tube of the cooling tube 2 communicates with the cooling flow channel 111. One of the two collecting tubes 1 is provided with a liquid inlet 15 and a liquid outlet 16.

When the cooling system is operating, the cooling liquid enters the cooling flow channel 111 through the liquid inlet 15 and enters the cooling tubes 2 while flowing along the cooling flow channel 111. The cooling liquid can cool the bottom of the unit cell while flowing in the cooling tube 2, and the circulated cooling liquid is discharged out of the cooling system through the liquid outlet 16.

In the present application, the connection between the collecting tube 1 and the cooling tube 2 is mainly achieved by improving the structure of the collecting tube 1, thereby improving the operation efficiency of the cooling system and increasing the energy utilization rate of the cooling system.

In an embodiment, as shown in FIGS. 7 and 10, the collecting tube 1 includes a body portion 11. The body portion 11 has a cooling flow channel 111. At the same time, the body portion 11 is also provided with a mounting hole 13. The mounting hole 13 is used for connecting the collecting tube 1 and the cooling tube 2. Along the width direction W of the battery pack, a limiting boss 14 is provided inside the mounting hole 13, and the limiting boss 14 is used to abut against the cooling tube 2. With the expression “abut against”, it is meant that the cooling tube 2 abuts against the limiting boss 14. The extending direction of the cooling tube 2 is the width direction W of the battery pack.

In the present application, by providing the limiting boss 14 in the mounting hole 13 of the collecting tube 1, the cooling tube 2 can abut against the limiting boss 14, so that the limiting boss 14 functions to limit the cooling tube 2 along the width direction W and realizes the connection between the cooling tube 2 and the two collecting tubes 1, and can limit the depth of the cooling tube 2 entering into the mounting hole 13 through the limiting boss 14. At the same time, after the limiting boss 14 is provided in the collecting tube 1, there is no need to provide a necking structure in the cooling tube 2, which can improve the production efficiency of the cooling system, and can avoid the increase of the flow resistance of the cooling liquid caused by the cooling tube 2 being provided with a necking structure and thus help to improve the energy utilization rate of the cooling system. The necking structure means that after the end of the cooling tube 2 is processed by the necking process, the opening corresponding to the end is reduced.

In an example, as shown in FIG. 10, the mounting hole 13 includes a first hole section 131 and a second hole section 132 along the width direction W (the axial direction of the mounting hole 13 is the width direction W), wherein the second hole section 132 communicates with the cooling flow channel 111 of the body portion 11. As shown in FIGS. 10 and 11, the size of the first hole section 131 in the height direction H is greater than the size of the second hole section 132 in the height direction H, and the size of the first hole section 131 in the length direction L is also greater than that of the second hole section 132 in the height direction H, so that the above-mentioned limiting boss 14 is formed between the first hole section 131 and the second hole section 132. The height direction H and the width direction W are perpendicular to each other. It should be noted that, as shown in FIG. 10, in the mounting hole 13, the first hole section 131 and the second hole section 132 are coaxial. Therefore, the size of the above-mentioned first hole section 131 or the second hole section 132 along the height direction H refers to the distance from the side wall of the corresponding hole section to the axis of the mounting hole 13 along the height direction H. Similarly, the size of the first hole section 131 or the second hole section 132 along the length direction L refers to the distance from the side wall of the corresponding hole section to the axis of the mounting hole 13 along the length direction L.

In the present embodiment, the mounting hole 13 for installing the cooling tube 2 in the collecting tube 1 is a stepped hole, so that the above-mentioned limiting boss 14 can be formed on the inner wall of the mounting hole 13. As shown in FIG. 7, the mounting section 21 of the cooling tube 2 protrudes into the first hole section 131 of the mounting hole 13, and abuts against the limiting boss 14, and the cooling tube 2 communicates with the second hole section 132 so that the cooling tube 2 communicates with the cooling flow channel 111.

As shown in FIG. 7, the inner diameter of the first hole section 131 is the same as the outer diameter of the cooling tube 2, or the inner diameter of the first hole section 131 is greater than the outer diameter of the cooling tube 2, so that the outer wall of the cooling tube 2 is attached to and welded to the inner wall of the first hole section 131, while ensuring the sealing between the two, reducing the possibility of the leakage of the cooling liquid from between the outer wall of the cooling tube 2 and the inner wall of the first hole section 131 and preventing the cooling tube 2 from falling out of the first hole section 131 when the battery pack vibrates.

In an embodiment, after the cooling tube 2 abuts against the limiting boss 14, the inner wall of the second hole section 132 is flush with the inner wall of the cooling tube 2, that is, the inner diameter of the second hole section 132 is the same as the inner diameter of the cooling tube 2. In the present embodiment, since the inner wall of the second hole section 132 is flush with the inner wall of the cooling tube 2 with no stepped surface between the two, the flow resistance to the cooling liquid can be avoided when the cooling liquid flows through, thereby reducing the energy loss when the cooling liquid flows and improving the energy utilization rate of the cooling system. At the same time, it can also improve the stability of the cooling liquid flow, thereby ensuring the uniformity of the cooling effect. It is understandable that the inner wall of the second hole section 132 being flush with the inner wall of the cooling tube 2 is not exactly level, as long as the inner walls of the two are substantially flush to reduce the flow resistance to the cooling liquid.

In an embodiment, as shown in FIG. 10, the first hole section 131 of the mounting hole 13 has a first side wall 131a. The cooling flow channel 111 has a second side wall 111a. The thickness of the first side wall 131a is greater than the thickness of the second side wall 111a. The thickness of the second side wall 111a is the thickness of the body portion 11. In the body portion 11, the wall thickness at the mounting hole 13 is greater than the wall thickness at the rest position of the body portion 11. That is, at the mounting hole 13, the strength of the collecting tube 1 at the mounting hole 13 can be improved by increasing the wall thickness, and thus the connection reliability between the collecting tube 1 and the cooling tube 2 in the radial direction is improved.

Further, as shown in FIGS. 10 and 11, in the mounting hole 13, the first hole section 131 is also connected to a third hole section 133, and the third hole section 133 and the second hole section 132 are respectively located on the two ends of in the first hole section 131 in the axial direction. Along the direction W1 from the third hole section 133 to the first hole section 131, the third hole section 133 has a tapered structure with a gradually decreasing cross-sectional area.

The cooling tube 2 is welded to the collecting tube 1 through the mounting hole 13. In an example, the outer wall of the cooling tube 2 is welded to the inner wall of the mounting hole 13. In the present embodiment, the third hole section 133 with a tapered structure can facilitate welding operations. At the same time, the third hole section 133 can also be used to contain solder, thereby effectively improving the connection stability between the cooling tube 2 and the collecting tube 1.

In each of the above embodiments, the body portion 11 is provided with a protruding portion 12 inside. The protruding portion 12 protrudes toward the inside of the body portion 11 in the width direction W (the axial direction of the cooling tube 2) and the height direction H. The protruding portion 12 extends along the length direction L of the collecting tube 1 and the protruding portion 12 is correspondingly provided with a plurality of mounting holes 13 along the length direction L. Each mounting hole 13 extends along the width direction W, and each mounting hole 13 is used to connect with the corresponding cooling tube 2. In the present embodiment, by providing the protruding portion 12 inside the body portion 11, the size of the mounting hole 13 in the width direction W can be increased, thereby increasing the length of the engagement between the cooling tube 2 and the mounting hole 13, which is beneficial to improving the connection reliability between the two.

In an embodiment, as shown in FIG. 10, a circular arc transition exists between the protruding portion 12 and the body portion 11, and the outer contour of the protruding portion 12 is a circular arc. Since the protruding portion 12 participates in enclosing the cooling flow channel 111 of the collecting tube 1, the arrangement of the present embodiment can prevent the cooling flow channel 111 from forming a bent position, thereby reducing the flow resistance of the cooling liquid in the cooling flow channel 111, increasing the energy utilization rate of the cooling system, and improving the uniformity of the cooling liquid flowing in the cooling flow channel 111, thereby improving the uniformity of the cooling effect of the cooling system for the battery module 4.

Further, as shown in FIG. 10, along the height direction H of the collecting tube 1, the body portion 11 has a first bottom wall 112 and a second side wall 111a. The second side wall 111a is a side wall close to the cooling tube 2. The protruding portion 12 is disposed on the first bottom wall 112 and the second side wall 111a, and is located inside the body portion 11. The protruding portion 12 protrudes from the first bottom wall 112 and the second side wall 111a.

In the present embodiment, when the collecting tube 1 is molded, the mounting hole 13 is disposed in the protruding portion 12 in the body portion 11 by machining, without adopting the processing manner of punching the mounting hole via a die in the prior art. Therefore, there is no need to reserve the wall thickness of the punching die in the collecting tube 1, so that the height of the mounting hole 13 can be reduced. At the same time, the collecting tube 1 in the present application can be directly molded by extrusion, thereby improving the production efficiency of the collecting tube 1, and making the chamfer at the bottom of the collecting tube 1 smaller or omitted, so as to enable further reduction of the height of the mounting hole 13. In this way, compared with the prior art, the mounting hole 13 in the present application is closer to the bottom of the battery pack, so that the cooling tube 2 is closer to the bottom of the battery pack, that is, the height of the entire cooling system in the battery pack can be reduced, and the energy density and group efficiency of the battery pack is improved.

In each of the above embodiments, as shown in FIGS. 2 to 4, along the length direction L of the collecting tube 1, the two ends of the body portion 11 are provided with blocking covers 3. The blocking cover 3 is used to block the cooling flow channel 111 along the length direction L, so as to prevent the cooling liquid from leaking from the end of the collecting tube 1.

In an embodiment, as shown in FIGS. 3 and 4, the blocking cover 3 includes a third side wall 31 and a second bottom wall 32, wherein the third side wall 31 is engaged with and welded to the inner wall of the body portion 11. The second bottom wall 32 can block the cooling flow channel 111. The third side wall 31 is provided with an inner concave portion 311 that engages with the protruding portion 12. The inner concave portion 311 is recessed toward the inside of the blocking cover 3, and the inner concave portion 311 is attached to and welded to the protruding portion 12.

Of course, the structure of the blocking cover 3 is not limited to this, and may be other structures. For example, the blocking cover 3 may be a flat plate structure, and the flat plate structure is attached to and welded to each of the two ends of the body portion 11 along the length direction L. In the present embodiment, the welding area between the blocking cover 3 and the body portion 11 is relatively large, which can improve the reliability of the connection between the two and prevent the blocking cover 3 from being disconnected from the body portion 11 under the action of hydraulic pressure.

In each of the above embodiments, as shown in FIG. 7, along the width direction W (the axial direction of the cooling tube 2), the cooling tube 2 includes a mounting section 21 and a cooling section 22. The mounting section 21 protrudes into the mounting hole 13, and the end of the mounting section 21 abuts against the limiting boss 14. The cooling section 22 is located outside the mounting hole 13. In an example, the cross-sectional area of the mounting section 21 is equal to the cross-sectional area of the cooling section 22. The cross-sectional area of the mounting section 21 and the cross-sectional area of the cooling section 22 being equal does not require exact equality in a mathematic sense, as long as the cross-sectional areas of the two are approximately equal. For example, the cooling tube 2 can be an equal-diameter tube, that is, the outer diameters of the cross sections perpendicular to the axial direction at various positions on the cooling tube 2 are equal in size.

In the present application, after the above-mentioned limiting boss 14 is provided in the mounting hole 13 of the collecting tube 1, the cooling tube 2 can abut against the limiting boss 14, and therefore, there is no need to install the necking structure in the prior art on the cooling tube 2. That is, the mounting section 21 of the cooling tube 2 has the same cross-sectional area as the cooling section 22, which can reduce the processing difficulty of the cooling tube 2, improve production efficiency, and prevent increase in the flow resistance of the cooling liquid caused by disposing the necking structure, and improves the energy utilization rate of the cooling system.

Further, embodiments of the present application also provide a battery pack, which includes a battery module 4 and a cooling system. The cooling system is used to cool the battery module 4, wherein the cooling system is the cooling system of any of the above embodiments. Since the cooling system has the above technical effects, the battery pack including the cooling system should also have corresponding technical effects, which will not be repeated here.

The above are only the preferred embodiments of the present application and are not intended to limit the present application. Any modification, equivalent replacement, improvement, etc. made within the spirit and principle of the present application shall be included within the scope of protection of the present application.

What is claimed is:

1. A cooling system for a battery pack, comprising:
a collecting tube comprising a body portion with a cooling flow channel;
a cooling tube, wherein the cooling tube is provided with the collecting tube at each of two ends of the cooling tube in an axial direction and is in communication with the cooling flow channel,
wherein the body portion is further provided with a mounting hole, a limiting boss is arranged inside the mounting hole, the limiting boss abuts against the cooling tube along a width direction, and the axial direction of the cooling tube is the width direction.

2. The cooling system according to claim 1, wherein an outer wall of the cooling tube is welded to an inner wall of the mounting hole.

3. The cooling system according to claim 1, wherein two collecting tubes are provided, and the two collecting tubes are respectively located at two ends of the cooling tube along the width direction.

4. The cooling system according to claim 3, wherein one of the two collecting tubes is provided with a liquid inlet and a liquid outlet.

5. The cooling system according to claim 1, wherein along the width direction, the mounting hole comprises a first hole section and a second hole section, the first hole section is in communication with the second hole section, and the second hole section is in communication with the cooling flow channel;
along a height direction and a length direction, a size of the first hole section is larger than a size of the second hole section, the limiting boss is formed between the first hole section and the second hole section, the height direction is the direction in which the collecting tube extends and is perpendicular to the axial direction, and the width direction, the length direction, and the height direction are perpendicular to each other.

6. The cooling system according to claim 5, wherein an inner diameter of the first hole section is the same as an outer diameter of the cooling tube; or, the inner diameter of the first hole section is greater than the outer diameter of the cooling tube.

7. The cooling system according to claim 5, wherein an outer wall of the cooling tube is attached to and welded to an inner wall of the first hole section.

8. The cooling system according to claim 5, wherein along the height direction, an inner wall of the second hole section is flush with an inner wall of the cooling tube.

9. The cooling system according to claim 2, wherein the first hole section has a first side wall, and the body portion has a second side wall; a thickness of the first side wall is greater than a thickness of the second side wall.

10. The cooling system according to claim 2, wherein the first hole section is further connected with a third hole section, and the third hole section and the second hole section are respectively located on the two ends of the first hole section along the width direction;
along the direction from the third hole section to the first hole section, the third hole section is tapered with a gradually decreasing cross-sectional area.

11. The cooling system according to claim 1, wherein along the width direction, the cooling tube comprises a mounting section and a cooling section;
wherein the mounting section protrudes into the mounting hole, the mounting section abuts against the limiting boss, and the cooling section is located outside the mounting hole;
a cross-sectional area of the mounting section is equal to a cross-sectional area of the cooling section.

12. The cooling system according to claim 1, wherein the body portion is provided with a protruding portion inside the body portion, the protruding portion protrudes toward the inside of the body portion in the width direction and a height direction and the protruding portion extends along a length direction;
along the length direction, the protruding portion is provided with a plurality of the mounting holes.

13. The cooling system according to claim 12, wherein along the height direction, the body portion has a first bottom wall, along the width direction, the body portion has a second side wall, and the second side wall is close to the cooling tube;
the protruding portion is disposed on the first bottom wall and the second side wall, and along the height direction, the protruding portion protrudes from the first bottom wall, and along the width direction, the protruding portion protrudes from the second side wall.

14. The cooling system according to claim 12, wherein along the length direction, both ends of the body portion are fixedly connected with a blocking cover, and the blocking cover blocks the cooling flow channel.

15. The cooling system according to claim 14, wherein the blocking cover comprises a second bottom wall and a third side wall;
wherein the third side wall is provided with an inner concave portion that is engaged with the protruding portion, and the third side wall is fixedly connected with an inner wall of the body portion;
the second bottom wall blocks the cooling flow channel.

16. The cooling system according to claim 15, wherein the third side wall is engaged with and welded to the inner wall of the body portion.

17. The cooling system according to claim 12, wherein a circular arc transition exists between the protruding portion and the body portion.

18. The cooling system according to claim 13, wherein a circular arc transition exists between the protruding portion and the body portion.

19. The cooling system according to claim 14, wherein a circular arc transition exists between the protruding portion and the body portion.

20. A battery pack, comprising:
a battery module comprising a plurality of unit cells;
the cooling system according to claim 1, wherein the cooling tube is arranged below the battery module, and a bottom of the battery module and the cooling tube are in contact with each other;
wherein the cooling system is configured for cooling the battery module.
